(19) United States
(12) Patent Application Publication
(10) Pub. No.: US 2023/0237507 A1
(43) Pub. Date: Jul. 27, 2023

(54) SYSTEM AND METHOD FOR GENERATING A DIGITAL VEHICLE IDENTIFICATION NUMBER

(71) Applicant: Robert Bosch GmbH, Stuttgart (DE)

(72) Inventors: Sekar KULANDAIVEL, Pittsburgh, PA (US); Jorge GUAJARDO MERCHAN, Pittsburgh, PA (US)

(21) Appl. No.: 17/585,059

(22) Filed: Jan. 26, 2022

(51) Int. Cl. G06Q 30/00

(52) U.S. Cl. CPC G06Q 30/0185

(57) ABSTRACT

A system and method for generating a digital identity of a vehicle. A first plurality of measurements may be generated from a plurality of electronic control units located within the vehicle. The measurements may be received by a backend service or a secured controller residing within the vehicle. The measurements may be generated using physics-based metrics unique to each of the plurality of electronic control units. A data pool may be created from the measurements. Also, a unique key operable to verify the digital identity of the vehicle may be generated by combining the data pool with error-correcting data.

### TECHNICAL FIELD

The present disclosure relates to improving vehicle security by generating a digital vehicle identification number based on one or more controllers within a vehicle.

### BACKGROUND

Vehicles have conventionally included a “Vehicle Identification Number” or “VIN” which is meant to be a unique code created by the manufacturer (e.g., Original equipment manufacturer or “OEM”). Once assigned, the manufacturer may physically etch the VIN into various original parts (e.g. engine block, door jamb, etc.) of the vehicle. Once the vehicle is sold, the various parts may then be visually inspected and the VIN may be used to confirm vehicle ownership or that a given part belongs with the corresponding vehicle. A vehicle's VIN may also be a unique identifier a vehicle's Electronic Control Units (ECUs) uses, e.g., to authenticate the vehicle when connected to diagnostic equipment and remote backend services. However, since the only method of verifying a vehicle's VIN requires physical access, a digital system currently has no method to ensure the validity of a vehicle that claims to own its assigned VIN. An adversary (or unauthorized user) may be able to spoof the physical VIN, authenticate the spoofed VIN with digital services, and ultimately falsify data associated with a given VIN.

### SUMMARY

A system and method of generating a digital identity for a vehicle. The system and method receiving a first plurality of measurements acquired from a plurality of electronic control units located within the vehicle. The first plurality of measurements may be physics-based metrics that are generated and unique to each of the plurality of electronic control units. The physics-based metrics may be an instantaneous energy value received from an energy source associated with the plurality of electronic control units. The first plurality of measurements may also be received from the vehicle to an external server using a secured transmission channel protocol.

Helper data may be generated from the first plurality of measurements. A data pool may then be created from the first plurality of measurements. Next, a unique identifier may be generated by combining at least two of the first plurality of measurements within the data pool. The unique identifier may also be operable to verify the digital identity for the vehicle. It is contemplated the unique key may also be stored on the external server. Also, the unique key may be combined with a single authentication protocol. The unique key may further be combined with a mutual authentication protocol. Lastly, a physical VIN associated with the vehicle may be received and the physical VIN may also be used to generate the unique key

It is also contemplated that the creation of the data pool may be repeated so that the data pool includes one or more features unique to the vehicle. The first plurality of measurements may also be represented as a single array of data. A unique key may also be generated using a fuzzy extractor algorithm operable to process a level of noise within the first plurality of measurements, wherein the fuzzy extractor algorithm uses the error-correcting data to adjust a measured fuzzy signal. Also, a fuzzy fingerprint may be generated to include an identity and a predetermined variance level for the first plurality of measurements. Finally, error-correcting data may further be computed from the data pool using a backend service.

It is further contemplated that the present method and system may send an identity verification request to the vehicle. A second plurality of measurements may be acquired from the plurality of electronic control units located within the vehicle. These second plurality of measurements may be physics-based metrics that are generated and unique to each of the plurality of electronic control units. The unique key associated with the second plurality of measurements may then be reconstructed by combining the second plurality of measurements with helper data generated from the first plurality of measurements. The digital identity of the vehicle may then be verified as valid using an authentication protocol to verify the unique key.

### BRIEF DESCRIPTION OF THE DRAWINGS

FIG. 1 illustrates an exemplary block diagram of implementation of a digital vehicle identification number (DVIN).

FIG. 2 illustrates an alternative exemplary block diagram of implementation of a digital vehicle identification number (DVIN).

FIG. 3 is exemplary charts illustrating a registration process which may be used during digital identification.

FIG. 4 is exemplary charts illustrating a verification process which may be used during digital identification.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Again, vehicles have conventionally included a “Vehicle Identification Number” or “VIN” which is meant to be a unique code created by the manufacturer (e.g., Original equipment manufacturer or “OEM”). Once assigned, the manufacturer may physically etch the VIN into various original parts (e.g. engine block, door jamb, etc.) of the vehicle. Once the vehicle is sold, the various parts may then be visually inspected and the VIN may be used to confirm vehicle ownership or that a given part belongs with the corresponding vehicle. A vehicle's VIN may also be a unique identifier a vehicle's Electronic Control Units (ECUs) uses, e.g., to authenticate the vehicle when connected to diagnostic equipment and remote backend services. However, since the only method of verifying a vehicle's VIN requires physical access, a digital system currently has no method to ensure the validity of a vehicle that claims to own its assigned VIN. An adversary (or unauthorized user) may be able to spoof the physical VIN, authenticate the spoofed VIN with digital services, and ultimately falsify data associated with a given VIN.

To overcome potential security issues, the present application contemplates a system and method for generating a Digital Vehicle Identification Number (DVIN). The DVIN may be generated by combining the physical VIN conventionally assigned by a manufacturer with a unique digital fingerprint generated using a vehicle's set (or subset) of controllers or electronic control units (ECUs) and their corresponding behavior during normal operation or during a fingerprint registration process. The generated DVIN may then be used by diagnostic equipment and remote backend services to verify a vehicle. For instance, the DVIN may be used to verify a vehicle is properly claiming to own the physical VIN physically located on one or more parts of the vehicle. Another example could include a vehicle that requests access to a cloud service. The DVIN could be used as an additional method to verify that the vehicle should be granted access to the service (in addition to presenting the standard VIN).

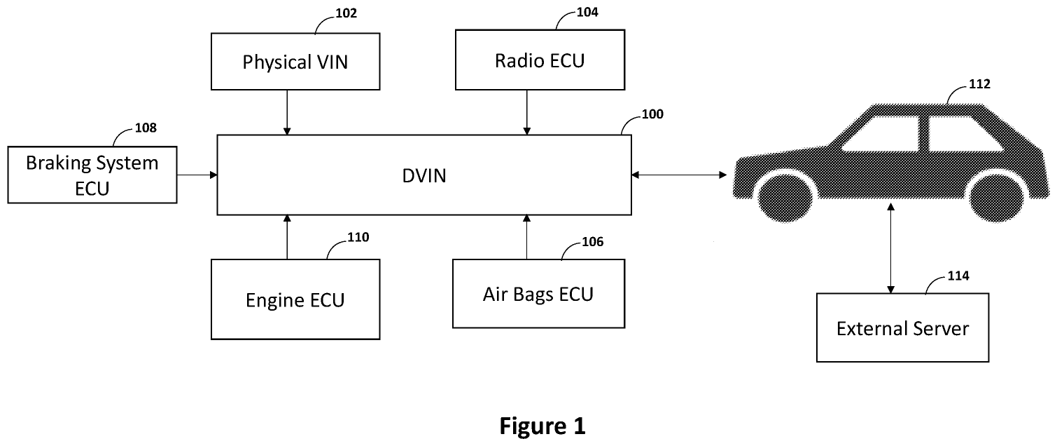

For instance, FIG. 1 illustrates a DVIN 100 that may be generated by combining the physical VIN 102 and the digital fingerprints from a radio ECU 104, air-bag ECU 106, braking system ECU 108, and an engine ECU 110. The VIN 102 may be assigned by a manufacturer (e.g., OEM) or supplier for a given vehicle 112. Likewise, the digital fingerprints register to a given control unit (i.e., radio ECU 104, air-bag ECU 106, braking system ECU 108, and an engine ECU 110) may be assigned at manufacturing or when installed within vehicle 112.

It is contemplated the DVIN may use physical measurements that are unique to ECUs along with digital signature schemes for enabling diagnostic equipment and remote backend services to successfully verify a vehicle's claimed identity. For instance, the disclosed system and methods contemplate generating a digital fingerprint without the need to rely on a Hardware Security Module (HSM) or Trusted Platform Module (TPM).

Again, the conventional approach currently implemented by manufacturers is identifying a vehicle using the physical VIN (e.g., VIN 102)—which may be a unique code created at manufacturing can be included (e.g., inscribed) onto several physical components of a vehicle. The physical VIN can be tied to a specific vehicle (e.g., vehicle 112) and may be intended to reduce the ability of a bad actor to spoof a vehicle's identity. However, as the proof of a vehicle's VIN is physical, it typically requires physical access to confirm the vehicle's identity. One potential vulnerability with such an approach is one or more electronic units within a vehicle (e.g., Electronic Control Units or “ECUs”) may store the vehicle's physical VIN in memory or some other digital storage. Since these ECUs can be replaced as part of a recall or repair, the physical VIN can be copied when replacing devices inside a car by using special diagnostic tools from the manufacturer.

The dangers associated with the physical VIN have become increasingly more prevalent as there have been recent database breaches storing millions of vehicle VINs associated with and including personal data of the vehicle's owner (e.g., customer names, phones, addresses, birthdates, gender, etc.). Bad actor's have been capable of using the stolen physical VINs and personal data to make a new VIN plate and to obtain a fake title to a vehicle. Once the bad actors have the stolen car and the physical VIN number from the database the vehicle can be re-sold to an unsuspecting buyer. Unfortunately, the buyer may not realize that the vehicle is stolen negating any recourse against the bad actors including obtaining any money used to purchase the stolen vehicle.

It is therefore contemplated the DVIN could provide several advantages over conventionally used physical VINs. First, the DVIN may be made unique per database. Second, the DVIN would not be a physical value stored in a vehicle or visibly on parts of the vehicle thereby negating the possibility the DVIN could be stolen or duplicated. Third, the DVIN can be generated such that it may be hard to replicate without proper and verified credentials.

Additionally, a physical VIN transmitted over one or more known data transmission interfaces (e.g., wired or wireless) may be spoofed since it is data stored physically within memory on the vehicle or visually present on one or more parts of the vehicle. Without the ability to verify the physical VIN, a remotely-connected system may not be able to confirm a physical VIN belongs (i.e., is assigned) to a specific vehicle.

The DVIN may therefore be operable in a manner like physical VINs, but the DVIN may not require physical access to verify authenticity. Instead, it is contemplated various software applications may be used to enable a digital service which in turn could authenticate a vehicle's identity. Also, the conventionally used physical VIN is visual and possibly acquirable if stored in a memory device within the vehicle to anyone with access to the vehicle. A DVIN, however, may be privately accessible to the vehicle owner since it would not normally be shared to other third parties. It is also contemplated the use of a programmed physical VIN may not provide sufficient authenticity since it can be easily changed or modifying by a bad actor. The DVIN may however uniquely identify vehicles by combining the physical VIN with one or more digital fingerprints.

The generation of the disclosed DVIN may also be based on enhanced sources of randomness from various sources within a vehicle. For instance, the sources may include using the timing distribution of response messages to Unified Diagnostic Service (UDS) messages or other chosen CAN messages between specific vehicle ECUs, a power distribution of a vehicle battery supply, the power signature of the software running in particular ECUs obtained by measuring the power consumption of the ECU when executing particular versions of software, or the power on state of Static Random-Access Memory (SRAM). The generation, operation, and usage of enhanced sources of randomness are contemplated and disclosed by U.S. patent application Ser. No. 17/445,758 which is incorporated herein by reference.

The sources that may generate strong sources of randomness may also be used for providing or generating fingerprints which are in turn used to generate the DVIN. For instance, the engine ECU 110 may include SRAM memory. While the cells within the SRAM memory may be neutrally skewed to produce secure random numbers, they may also be skewed positively or negatively to produce secure fingerprints for a particular. Selection of the right set of measurements may then be used to produce a fingerprint for a single device (e.g., ECU 110). The present disclosure contemplates using one or more fingerprints to generate an identity for the entire vehicle. The disclosed system and method may then be used to build a fingerprinting that is indicative of a vehicle instead of just a single ECU or controller. The digital fingerprint may be used to create the DVIN to ensure that uncompromised vehicles can only claim to own a given VIN.

The disclosed system and method may also provide a digital fingerprint for the vehicle's ECU which in turn may be used to help uniquely identify a vehicle. For instance, the digital fingerprint may include measurements from all or a subset of a vehicle ECU's without requiring additional hardware (e.g., an additional Hardware Security Module or Trusted Platform Module). Without the need for additional or unique hardware, the disclosed system and method may be applied to numerous activities where verification of a vehicle's identity may be needed but physical access to the vehicle may not be easily possible to obtain. For instance, the systems and methods may be applied to provide fingerprinting for fleets of vehicles (e.g., for ridesharing or autonomous vehicle fleets), to a specific make and model of the vehicle (e.g., Ford Mustang Mach-E), or vehicle with a certain physical component (e.g., an EV-vehicle with a specific battery module).

It is further contemplated the disclosed system and method may not require modifications or hardware beyond what currently exists within a vehicle. Instead, the disclosed system and method may be operate using the existing hardware currently included within a vehicle and can be implemented through software modifications to currently existing ECUs. It is also contemplated the disclosed system and method may not require intensive processor operations as much of the required processing to generate a fingerprint can be done by a remote back-end server. The fingerprint itself may therefore be stored external from a particular vehicle and the back-end server may perform the operations of determining any one vehicle's digital fingerprint. Lastly, it is contemplated the proposed system and method may be applicable to non-automotive applications that include aerospace, industrial control, and building control technologies.

The DVIN contemplated may therefore provide security properties beyond those currently provided by a vehicle that bad actors can compromise. For instance, the disclosed system and method may help reduce the ability of a bad actor from compromising hardware and/or software within a vehicle. If the bad actor cannot compromise the vehicle's hardware or software, then a remote backend may be able to request a DVIN and obtain a valid fingerprint for the vehicle.

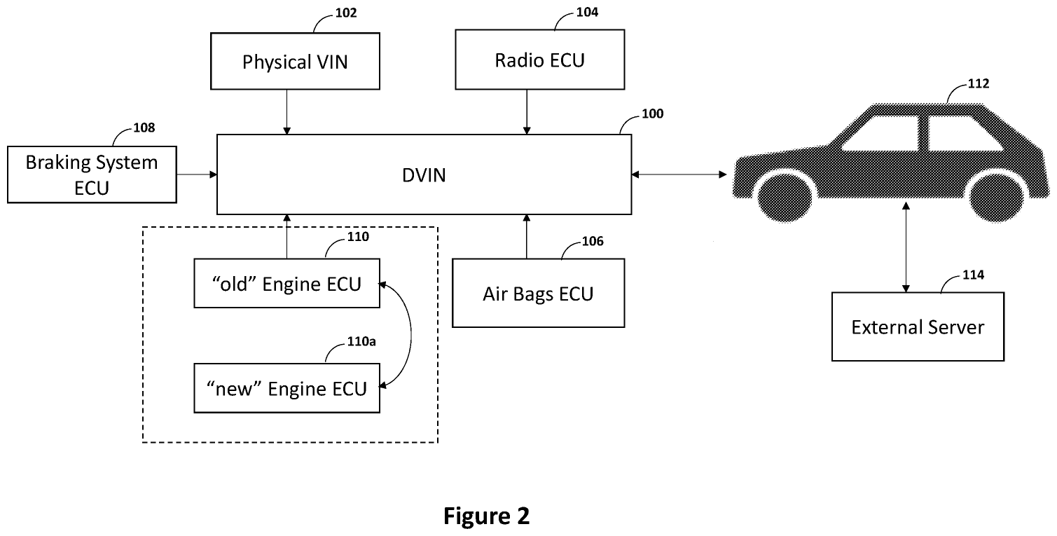

The disclosed system and method may also assist with hardware modifications or changes that a given vehicle (e.g., vehicle 112) may undergo. For instance, FIG. 2 illustrates the DVIN 100 described above with reference to FIG. 1. As illustrated, a vehicle owner may voluntarily modify hardware within their vehicle (e.g., replacing engine ECU 110 with engine ECU 110a). During such a modification a secure mechanism should be used to register the fingerprint for the new hardware or subsystem. For instance, if engine ECU 110 is replaced with engine ECU 110a, the installer may provide the old DVIN (e.g., DVIN 100) and the fingerprint for the new engine ECU 110a to generate a new DVIN (not illustrated) for vehicle 112.

Additionally, the disclosed system and method may be used during a software compromise. If the bad actor can compromise the software of an in-vehicle ECU (e.g., ECU 110), it would be essential to detect such a compromise because a bad actor could aim to spoof a new DVIN. However, if the bad actor compromises the software of a single (or subset of) ECU (e.g., ECU 110) without affecting or compromising all other ECUs (e.g., ECUs 104, 106, 108), the bad actor may be unsuccessful at compromising the DVIN. It is also contemplated identifying an invalid fingerprint or invalid DVIN would be necessary when a bad actor impacts traffic by compromising the output of one or more ECUs.

The present system and method are intended to reduce the ability of a fingerprint being modified or spoofed because the fingerprint for vehicle 112 may be based not a single ECU but a multitude of ECUs (i.e., ECU 104-110). To spoof DVIN 100, a bad actor would have to modify the fingerprint from a large number of ECUs within vehicle 112. For instance, if the DVIN 100 is generated using fingerprints from 20 devices within vehicle 112 (including ECUs 104-110), the bad actor would need all 20 unique fingerprints used to generate the DVIN. A bad actor would therefore need to modify the fingerprint from all units (i.e., ECUs) from vehicle 112 which would be difficult and expensive.

Lastly, the present system and method may be used during a hardware compromise. For instance, a bad actor may be capable of compromising the hardware of ECU 110. Once compromised, the information obtained from ECU 110 could be used to target a handful of vehicles at a time. Likewise, if a bad actor has this level of access, they can launch higher impact attacks (e.g., remote access to vehicle controls) where modification of the fingerprint is not the intended goal. By generating a DVIN from multiple unique fingerprints, a physical security may be established that negates the ability of bad actors from accessing or controlling a vehicle which they do not own. The DVIN (e.g., DVIN 100) may therefore be operable to produce a digital fingerprint that is tied to a physical VIN (e.g., VIN 102) as long as a bad actor does not compromise the actual hardware of vehicle 112.

To generate a digital fingerprint for vehicle 112, a secure source for the vehicle's identity needs to be selected. This may be achieved by seeking a metric that can be measured for a given ECU (e.g., ECU 110). Once a metric is selected, the fingerprint can be generated from the combination of these multi-ECU measurements (i.e., measurements for all ECUs being used). Again, multiple units within the vehicle 112 (e.g. ECUs 104-110) may be used to ensure that an adversary in control of at least one ECU (e.g., ECU 104) cannot falsify or spoof a vehicle's identity. The metric selected may also rely on physical properties which may be difficult to spoof, replicate, simulate, and/or copy (e.g., like human biometrics).

Since it may be difficult for an attacker to modify a physical vehicle (especially for large-scale attacks), physics-based metrics like voltage and timing may be employed. Evaluation of the measurements of physics-based metrics collected may also need to be evaluated to ensure a secure fingerprint is being generated. For example, as explained above a skewed a memory unit within a given ECU (e.g., SRAM cell) may be used to provide a fingerprint. Thus, when a given ECU (e.g., ECU 110) is selected it may therefore be requested to provide a measurement of its SRAM. Assuming ECU 110 had not been tampered with, an attacker in control of the software for ECU 110 might be capable of modifying the SRAM fingerprint. It is therefore contemplated that for each individual ECU (e.g., ECU 110) that will be requested to provide measurements, consideration should be given as to how an adversary could compromise those measurements. The consideration should ensure that both the physical and software components of an ECU may not be susceptible to compromise.

As explained above, power measurements may be collected as disclosed by U.S. patent application Ser. No. 17/445,758 which is incorporated herein by reference. The power measurements may also be collected while the software is running and a software fingerprint may then be generated. The strength of the fingerprint may depend on the selected metric and the ability for an adversary to duplicate or simulate the fingerprint. However, if a compromised ECU affects network traffic, then any collection of message timings will identify a spoofed DVIN and detect the presence of a bad actor.

It is also contemplated the fingerprint data for a given ECU should only be measurable from a system external to vehicle 112. For instance, FIG. 1 illustrates vehicle 112 being operable to communicate with external server 114. It is contemplated vehicle 112 may be able to communicate with external server using a wireless communication protocols (e.g., WIFI, cellular, or BlueTooth) or wired communication protocol. It is also contemplated the ECUs (e.g., ECUs 104-110) within vehicle 112 should not store the fingerprint stored on server 114. Instead, the ECUs should be operable to provide metrics for the server 114 (i.e., external system) to measure. The storage on the external system like server 114 should be tamper-resistant. It is also contemplated vehicle 112 may not be operable to communicate with server 114 during or with regards to the creation of the signature. Instead, server 114 may run a backend service for creating the signature after having collected the physical measurements from the vehicle ECUs in a secure environment (an environment that can be guaranteed not to be under the control of a malicious attacker for limited period of time).

The signature may not be stored in a memory unit located within vehicle 112 and vehicle 112 should not be involved with server 114 creating the signature to provide security guarantees of a unique identifier (i.e., a signature that has not been impacted or compromised by an bad actor). Thus, the backend service operating on server 114 may be used to build a fingerprint from the measurements that vehicle 112 provides. In certain applications, the vehicle fingerprint may be provided and verified by third parties, and the ability to verify the fingerprint may not be limited to just one trusted party. The fingerprint should also be generated by vehicle 112 whose fingerprint is being verified. It is contemplated that if a party cannot modify the fingerprint, then vehicle 112 may be operably tracked for purposes of advertisement, toll tracking, etc. Also, the fingerprint may be designed to include immutable characteristics from vehicle 112 therefore further ensuring a bad actor cannot spoof a given fingerprint.

Again, the physics-based metric used to generate the measurements used for the fingerprint may be generated like methods used for generating biometric human fingerprints. For instance, biometric fingerprints attempt to assess unique characteristics to identify a specific person. If measurements pertaining to every single ridge on a person's finger was attempted, a strong signature may not be obtainable. In real-world practice, the measurements obtained from a person's fingerprint may not always be the same (e.g., variance may occur due to noise). As a result of physical variation in the collection process (e.g., pressure, ink coverage, noise, etc.), a fingerprint will not look the same, but certain features can still be measured that can be tied to an individual. The present system and method contemplates similar challenges may exist when measurements are obtained in the digital world. For instance, the metrics collected may derive a fingerprint that produces a “fuzzy signature” (i.e., a signature that may not look exactly the same each time). It is contemplated that if the same signature is not consistently produced, various cryptographic techniques may not be usable since the same key would be expected.

It is therefore contemplated that a fuzzy cryptographic algorithm may be employed to create a unique digital vehicle identity that can be used for cryptographic signature schemes. The “fuzzy fingerprint” which may include (1) an identity; and (2) acceptable variance between separate measurements. A fuzzy extractor may then be employed to extract the generated identity from the input when the extracted identity falls within the acceptable variance. This variance depends on the construct used by the fuzzy extractor. The extractor relies on error-correcting codes to adjust the measured fuzzy signature and create the true fuzzy signature. These codes only work under this acceptable variance, thus we can ensure that an identity is true as long as an adversary cannot replicate the inputs (or even get close to it). Once we use the fuzzy extractor to derive a key, we can use this key as a unique digital vehicle identifier and for any known cryptographic signature schemes.

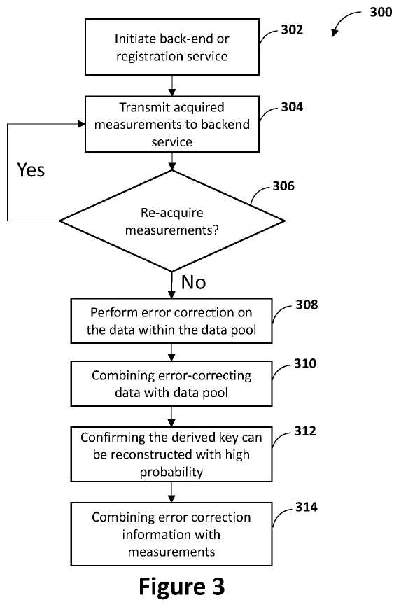

FIG. 3 illustrates a flow diagram 300 of a registration process used in deriving a vehicle identity in the form of a key using a fuzzy extractor. At step 302, a back-end/registration service may first be initiated. The back-end/registration service may operate on the server 114 external to the vehicle 112. The back-end/registration service may initiate processes that should be started depending on the chosen metric for the digital identification. For instance, vehicle 112 may transmit physical VIN 112 to the backend (i.e., server 114) where a database may be searched to locate the expected fingerprint through its registration. Again, the metric selected should be physics-based and should not be easily modified (copied, simulated, spoofed, etc.) by a remote adversary. It is also contemplated the registration process for a DVIN (e.g., DVIN 100) should also be stored in a secure environment/location (e.g., tamper-resistant memory residing on server 114) that may not be accessible or subjected to adversarial control by a bad actor. Alternatively, the database could be indexed by the VIN so that one does not need to search for the closest match of the fingerprint but to simply verify that the fingerprint corresponds to the VIN. The VIN in this case can be the traditional VIN or an additional unique identifier used by the service provider to identify the vehicle. Another example of such an identifier could be created by computing the hash of the helper data (error correcting data) associated with a particular DVIN. In this case the database would likely consist of at least three columns: one column with the hash of the helper (error correcting) data, one column with the helper data itself, and one column with the expected fingerprint. In some implementations the third column might not be necessarily included.

At step 304, vehicle 112 may also transmit acquired measurements to the server 114 operating the backend service. The backend service may collect the “fuzzy signatures” (i.e., signals) and may use the collected fuzzy signatures to produce a data pool. At step 306, flow diagram 300 will determine if the acquisition and data pool process should be repeated. If yes, step 304 may be repeated so that the backend service can characterize the features that are unique to vehicle 112 or which may be considered optimal (i.e. more robust) for identifying vehicle 112. It is contemplated these measurements may be taken from several ECUs (e.g., ECUs 104-110) in the vehicle network. As discussed above, the measurements would preferably not be taken from a single source (i.e., single ECU). The measurements from multiple ECUs may also be represented as a single data array. The created data array may be a concatenation of all measurements thereby accounting for the noisy measurement within the vehicle 112.

At step 308, the backend service may then perform an error-correcting algorithm on the data within the data pool. The type of error-correcting may vary depending on the chosen construct. At step 310, the backend service may combine the error-correcting data with the data pool. At step 312, the backend service may confirm the derived key can be reconstructed with high probability from the vehicle measurements. It is contemplated the confirmation may provide proof of identity and may be combined with single or mutual authentication protocol depending upon a given application. At step 314, the error correction information may then be combined with the measurements (i.e., “helper data”) which may be securely stored on server 114 where backend service operates.

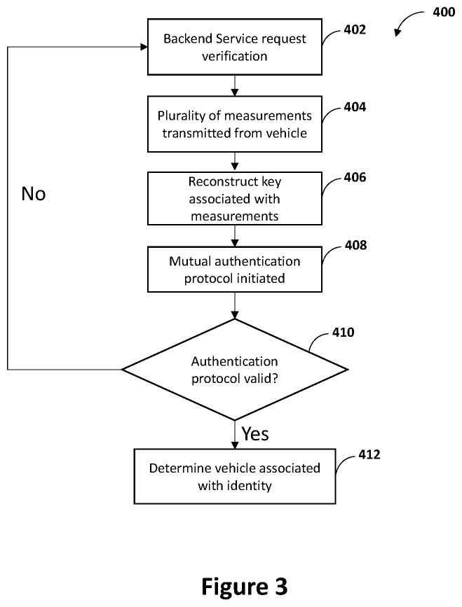

FIG. 4 illustrates a flow diagram 400 of a verification process that may be implemented by the backend service request a query or verification of a DVIN (e.g., DVIN 100). At step 402, the backend service may begin by requesting verification of the identity from vehicle 112. At step 404, vehicle 112 may transmit a plurality of measurements acquired from internal ECUs (e.g., ECUs 104-110) to the backend over a confidential and authenticated channel. For instance, vehicle 112 may transmit the measurements using a secure channel like a Transport Layer Security (TLS) which may be used to encrypt transmitted data.

At step 406, the backend service may reconstruct the key associated with the measurements received from the vehicle 112. The backend service may include a helper data algorithm that reconstructs the key by combining the current measurement with the helper data. At step 408, the backend service may initiate a mutual authentication protocol with the vehicle 112. At step 410, the backend service may determine if the authentication protocol is valid. If yes, the backend may determine which vehicle (e.g., vehicle 112) corresponds or is associated with the claimed identity. If no, the backend service may determine the request is invalid and may return to step 402 to re-initiate the request. It is also contemplated an error message may be generated alerting that an invalid authentication has been generated.

It is contemplated flow diagram 400 may assume there is a claimed identity associated with the vehicle measurements. The claimed identity could be the physical VIN (e.g., VIN 402) in applications aimed at verifying the information associated with vehicle 112. For instance, the claimed identity may be used to prevent vehicle 112 from being stolen and a fake VIN associated with vehicle 112 being generated and presented to an unsuspected buyer.

In other applications, flow diagrams 300 and 400 might be used when there exists the possibility of a spurious identity. For example, the backend service could assign to the vehicle a random identity. Alternatively, in some applications there may not be a fixed identity being claimed by the vehicle. In such situations the backend service may try to identify vehicle 112 based on the measurements performed. In this instance there may be a linear computation overhead associated with finding the best match for a particular identity.

It is further contemplated when implementing the fuzzy extractor a fingerprint may be reconstructed the same key each time. As such, the key may be used for normal signature schemes, such as digital signature and identity verification. However, to further ensure the ability to use the key for such signatures or verification, additional operations may also be incorporated.

For example, an off-vehicle fingerprinting process may be implemented where the measurements that serve as input to the fuzzy extractor (such as network message timing or data point voltage) may be transmitted from vehicle 112 to server 114 (i.e., backend service). The backend service may compute the fingerprint and if the backend service determines the fingerprint may be used to reconstruct the same key each time, the derived key may be used for normal signature schemes (e.g., digital signature and identity verification).

When an off-vehicle fingerprinting process is employed, a secure gateway or trusted set of ECUs may operate to transmit the network data to the backend service over an encrypted secure channel. The secure channel may be established such that a bad actor cannot eavesdrop on this network data and potentially derive the fingerprint. With regard to the backend service, an error-correcting code may be used for the fuzzy extractor and to reconstruct the key. The error-correcting code may be established to allow implementation of a normal signature scheme.

It is also contemplated the off-vehicle fingerprinting may be used for other applications such as those between an OEM and an advertiser (or some other third-party other than an OEM). For instance, the OEM may operate as an intermediary between an advertiser and vehicle 112. In this example the advertiser may request confirmation that its advertisements reach an appropriate vehicle (e.g., vehicle 112). The advertiser may also want to prevent the OEM from extracting certain information or data from the advertiser. As such, vehicle 112 may transmit network data for the purpose of fingerprint to an OEM backend service (e.g., using server 114). Based on the request, the OEM may forward the network data received from vehicle 112 to one or more advertisers. The advertisers may employ an individual fuzzy extractor which may be different from the fuzzy extractor discussed above. Since each advertiser can implement their own unique fuzzy extractor, the advertiser may be operable to maintain their own version of a given vehicle's identity (e.g., identity for vehicle 112). As such, advertisers may not need to share a single fingerprint with OEM or a third-party. The separate fingerprint may allow the advertiser (or third-party) from maintaining security of identities (i.e., hide identities) from the OEM in case the derived identities are considered proprietary to the advertiser.

It is also contemplated that an on-vehicle fingerprinting process may be implemented where a single secure gateway or some trusted set of ECUs (e.g., ECUs 104-110) may measure the network data on vehicle 112. Based on the measurement the on-vehicle fingerprinting process may compute a key with an onboard fuzzy extractor. Here, the secure ECUs on vehicle 112 can perform any necessary pre-processing and compute the keys which would be transmitted to the backend service (e.g., backend service operating on server 114). The on-vehicle fingerprinting process should ensure that each ECU (e.g., ECU 110) provide data to the fuzzy extractor which can produce the same response each time. Again, the response may depend on the metric employed. Since an adversary may be able to spoof the data that originates from non-physics-based information (e.g. SRAM fingerprint), it is contemplated diversification of the fingerprint should be employed. Also the on-board fingerprinting process should ensure that it is not easily hackable or compromised by malicious actors. This is often achieved in practice by using tamper evident or resistant hardware or an intrusion detection system that detects when the system has been compromised.

An alternative approach to the on-vehicle fingerprinting process may include concatenating the fingerprints from each ECU (e.g., ECUs 104-110). The process may operate on the assumption each sub-fingerprint (e.g., fingerprint for ECU 110) is somewhat fuzzy. The process may also include error-correcting codes to address potential mistakes across the concatenated fuzzy input. To determine the efficacy, the process may measure how far each sub-identity is from the expected sub-identity and define a threshold. As long as the sub-identity falls within the threshold as defined by the chosen error-correcting codes, the process may generate a digital fingerprint and produce a key for any normal signature scheme. The process may be operable to further compare fingerprints without the error-correcting code to verify a vehicle correctly claims its assigned identity. Care should be taken that not all fingerprints can be easily read by an eavesdropper attacker listening to the communication between the ECUs (whose fingerprint is being measured) and the server that is collecting the fingerprints for verification.

It is contemplated that with regard to the above-discussed approach no single ECU may have knowledge of its fingerprinting information. Instead, the fingerprinting information would simply be an input to the fuzzy extractor. As such, an adversary who compromises an ECU (e.g., ECU 110) may not be able to modify the fingerprint due to uncovering the actual fingerprint. Likewise, the above processes operate based on a fingerprint being derived from multiple ECUs (e.g., ECUs 104-110) rather than from just a single ECU (e.g., ECU 110).

It is also contemplated that how many types of metrics must be used may be dependent upon what type of metrics may be used. For instance, depending on the chosen metric, the disclosed system and methods can define various approaches to fingerprinting. The defined approach may rely on just a single metric and just one type of measurement from all ECUs (i.e., homogenous fingerprinting). It is contemplated that homogenous fingerprinting may operate by selecting a metric that cannot enable an adversary to falsify a vehicle's identity (e.g., identity of vehicle 112). The metric may be the same for each ECU in vehicle 112. As such, the selected metrics (e.g., power or timing distributions) may be relied upon since it would be difficult for an adversary to falsify and control.

However, the present method and systems contemplate that an adversary can falsify some of its data to force the backend service to produce a different identity. For instance, the disclosed system and methods may select SRAM fingerprints as the desired input. Since the SRAM fingerprint may be measured with software and the fingerprint may be sent by each ECU (e.g., ECU 110) to the backend service, a remote attacker in control of software can compromise the generated fingerprint or information. As a result, a heterogeneous fingerprinting process may be employed where another physics-based metric may be selected to use in combination with this software-measured metric. The diversification of metrics can ensure a better chance of detecting an incorrect fingerprint.

It is contemplated the ability to digitally identify a unique vehicle may play a significant role in the automotive domain. For instance, the disclosed system and method of providing digital authentication of a vehicle may include: (1) providing tailored or targeted services depending on vehicle identity; (2) the capability of detecting fraud when a vehicle claims a VIN it does not own; (3) detecting fraud by identifying altered vehicle operations; (4) and detecting a compromise of in-vehicle network communication.

With regard to providing tailored or targeted services, the remote backend service may be operable to provide services based on the identity of a given vehicle (e.g., vehicle 112). As discussed above, the tailored or targeted services may include using targeted advertisements that will receive the DVIN 100 of vehicle 112 and use data from the vehicle's network (i.e., network data or information) to select certain advertisements that may be displayed within the vehicle (e.g., on an infotainment system). Such targeted advertisements might operate in a manner similar to web browsers that are configured to track user operations of navigating between websites by monitoring a computer processes.

For targeted services or advertisements, the disclosed system and method a digital fingerprint may be generated as part of the DVIN (e.g., DVIN 100) which may then be transmitted the remote backend service (i.e., server 114). The backend service should be operable to extract the DVIN 100 and some data from vehicle 112 for the purpose of tailored or targeted services (e.g. advertisements). For instance, it may be assumed an attacker has not compromised vehicle 112 or one or more of its ECUs (e.g., ECUs 104-110). If a bad actor cannot compromise either the hardware or software of vehicle 112, the remote backend service should be operable to request DVIN 100 be transmitted and backend service should be operable to obtain a valid fingerprint without concerns of spoofing.

For targeted services or advertisements, vehicle 112 may transmit both its claimed VIN (e.g., VIN 102) and network data to an advertisement server. The advertisement server may operate similar to server 114 discussed above, and vehicle 112 may connect to advertisement server using a wireless or wired connection as discussed above. From the data transmitted from vehicle 112, the advertisement server may be operable to generate a fingerprint by looking for specific features in the timing of network messages and perhaps the voltage of certain message data points. Once the advertisement server generates a digital fingerprint, it will have a DVIN (e.g., DVIN 100) for vehicle 112, which is essentially a digitally-verified VIN.

The advertisement server may then send targeted content to vehicle 112 with the knowledge that the advertisements match the intended vehicle. Additionally, the advertisement server can communicate with other backend services on behalf of vehicle 112. For instance, an advertisement server that is owned by the OEM can communicate with other affiliated advertisement companies. The OEM could therefore control access to the network data or information transmitted from vehicle 112. The OEM could therefore ensure data from advertisement companies is securely and properly sent to an intended vehicle (e.g., vehicle 112).

With regard to the capability of detecting fraud when a vehicle claims a VIN it does not own there may be several applications where a remote backend service may need to detect fraud when a vehicle claims to own another vehicle's VIN (e.g., VIN 102). For instance, one application may include the ability to authenticate vehicle 112 and/or an infrastructure which are part of a vehicle to everything (V2X) communication protocol. Since V2X systems rely on valid information from other vehicles or infrastructure, the disclosed system and method may need to authenticate and identify a given vehicle (e.g., vehicle 112). If vehicle 112 transmits its vehicle information to nearby V2X nodes, those devices can confirm DVIN 100 and prevent vehicle 112 from repudiating its transmissions. The confirmation can protect vehicle 112 against bad actors that intentionally spoof malicious information by tying the transmitted information to the sending vehicle. Likewise, DVIN 100 could be used to tie a toll collecting device directly to vehicle 112. Again, this can prevent bad actors from swapping vehicle plates or toll collecting devices to avoid paying for tolls by charging tolls to other vehicles other than vehicle 112.

As mentioned before, a DVIN (like DVIN 100) can also provide a weak form (not cryptographically enforced) of non-repudiation to enable proof that a bad actor misused the toll collecting device. The benefit of a DVIN over a physical VIN (like VIN 102) is that usage of DVIN 100 can ensure vehicle 112 actually owns VIN 102 that it claims to own and any spoofing may be detected without requiring physical verification. Such detection may only be probabilistic since it may fail with certain probability that is non-negligible as opposed to a method rooted on cryptography. However, the disclosed system and method can be used without cryptography or in combination with cryptography, including cases where the cryptography is designed to be anonymous.

When detecting a false toll collecting device (similar to the prior application related to targeted ads or services) may include a bad actor intentionally that attempts to use the wrong toll collecting devices so that any toll charges get sent to the victim's account. For example, imagine someone steals another vehicle's toll device and uses it in their own vehicle. If this toll device were connected to vehicle 112, the toll device could collect the vehicle network data and send this data to a remote server (e.g., server 114) like a toll station. In operating as the remote backend service, the toll station could use the received data to confirm DVIN 100 by generating a digital fingerprint. Without this confirmation, the toll station may not charge the account tied to the claimed VIN (e.g., VIN 102) and may instead produce an alert indicating a possible spoof or fraud.

Another example may include detecting a spoofed vehicle operation or applications where a vehicle may include a dongle supplied by a insurance or car-rental service. In such an application, a remote backend service may operate to detect fraud where a bad actor intentionally alters the operation of vehicle 112.

For instance, vehicle 112 may be operable to perform an over-the-air (OTA) update using a wireless connection. In performing the OTA update, vehicle 112 may need to present its identity to a backend service (i.e., transmit data to server 114). A potential method for providing secured communication would be for vehicle 112 to provide remote attestation or public-key cryptography. But such secured communications typically require significant changes to vehicle hardware and thus increased cost. But, if an attacker has compromised the network traffic within a vehicle and altered the operations of vehicle 112, DVIN 100 could detect these alterations.

Also, a backend service that may require vehicle identification include insurance or rental car dongles that track a vehicle's movements. For insurance dongles, it may be necessary for insurance companies to verify the dongle is connected to the underwritten vehicle (e.g., vehicle 112). If the dongle simply requests VIN 102, the information supplied can be easily spoofed over the in-vehicle network. Like the above discussion regarding tricking a toll collecting device, a bad actor can plug an insurance dongle associated with vehicle 112 into another vehicle that may produce a lower insurance rate. For instance, the lower rate may be associated with a pay-as-you-drive or pay-how-you-drive plan. An attacker could not only provide the wrong VIN, but they could also simulate driving data to get the lower rate.

Using DVIN 100 would potentially negate such unwanted activities since the attacker would need to modify both the VIN (e.g., VIN 100) and the network traffic. Likewise, rental car companies that track a vehicle's actions can use DVIN 100 to ensure a tracker has not been moved from vehicle 112 to another vehicle. DVIN 100 can also protect an insurance company if the rental company tries to track a vehicle's location, monitor if a vehicle is driven safely, or check for usage to determine rental pricing. The benefit of a DVIN (i.e., DVIN 100) over a VIN (i.e. VIN 102) is the DVIN may operably tie the operations of vehicle 112 to VIN 102 by generating a digital fingerprint that consists of a vehicle's unique network and physical characteristics. As mentioned previously, an attacker might attempt to remove the original VIN (i.e., VIN 102) and replace it with a fake one with the hope that an unsuspecting buyer will not realize that vehicle 112 has been stolen. In this case, DVIN 100 may also make clear that VIN 102 does not correspond with DVIN 100.

It is further contemplated detecting spoofed vehicle operations to defraud insurance dongles can also include whether the bad actor either (1) attaches a new device to their own vehicle to spoof network data on vehicle speed, turning, etc. with the intent to simulate a “better” driver or (2) connects their insurance dongle into someone else's vehicle (i.e., other than vehicle 112) with the intent to use a “better” driving for a lower rate. With an insurance dongle connected to the diagnostics port of vehicle 112, a company may be able to check for a VIN (e.g. VIN 102), which can be easily spoofed over the network. In both cases, the company would be defrauded and charge a lower rate. However, with a DVIN (i.e., DVIN 100) the company can detect fraud in both cases. For example (1) the company may be able to detect incorrect message timings due to the bad actor sending their own transmissions, which will cause the digital fingerprint to not match the expected fingerprint. For example (2), the company can measure the digital fingerprint of the other vehicle's network and find that the fingerprint does not match the claimed VIN (i.e., VIN 102).

Lastly, there may be several applications where a remote backend server can detect a compromise on the in-vehicle network communication. For instance, DVIN 100 may be used to detect malicious modifications to a vehicle's network traffic to protect any services that connect to the vehicle. Such an application may be applicable when an attacker remotely compromises one or more ECUs (i.e., ECUs 104-110) in vehicle 112 and then uses an ECU (e.g., ECU 110) to spoof network traffic. For example, if a vehicle 112 were compromised and connected to an electric vehicle charging station, the station could collect DVIN 100 prior to providing power. As such, verification may be used to ensure: (1) the appropriate vehicle is charged for the power costs; (2) the vehicle or bad actor are not able to infect the charging station (or other remote servers; (3) the location of the vehicle may be tracked based on the charging station's location.

Also, when a vehicle is not updated or requires a forced update due to malicious compromise, a backend service could detect the forced update or malicious compromise if DVIN 100 is generated correctly. The benefit in this application of a DVIN over a VIN is that DVIN 100 cannot be spoofed and it therefore ensures vehicle 112 and its network operations are not maliciously modified. The use of DVIN 100 can protect both vehicle 112 and any services it connects to, enabling some level of trust between these two parties.

For instance, a bad actor may successfully compromise ECUs (i.e., ECUs 102-110) within an electric vehicle (i.e., vehicle 112). The bad actor may also intend to plant a virus or worm on vehicle 112 hoping it can pass on the virus or worm to a charging station the next time vehicle 112 needs charging. The virus and worm being passed between vehicle 112 and other vehicles or stations can spread very quickly. To protect both the charging infrastructure and other vehicles, the charging station can use DVIN 100 to ensure that vehicle 112 is not compromised. This is again demonstrated by the application of vehicle 112 being connected to an external charging station. Once connected, the station may observe the network traffic and voltage of data points from vehicle 112. As long as the bad actor only compromised software within vehicle 112 and transmits malicious data on the network, the station can identify an invalid digital fingerprint and block vehicle 112 from further communication with the station. Since the charging station may need to communicate with payment services, it is safe to assume that the charging station communicates with a registration service as an intermediate step. By detecting such malicious behavior, the station can effectively protect itself and other vehicles that connect in the future. Similar to other applications discussed above, DVIN 100 can prevent any electric vehicle owner from simply spoofing another vehicle's VIN where another driver may be assessed the fee for charging time.

While the above-discussed examples are not a complete list of all potential applications, each are intended to demonstrate the flexibility and diversity of how a DVIN (e.g., DVIN 100) may be used to provide enhanced security where confirming a vehicle's identity is critical.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of generating a digital identity for a vehicle comprising:
receiving a first plurality of measurements acquired from a plurality of electronic control units located within the vehicle, wherein the first plurality of measurements are physics-based metrics that are generated and unique to each of the plurality of electronic control units;
creating a data pool from the first plurality of measurements; and
generating a unique identifier by combining at least two of the first plurality of measurements within the data pool, wherein the unique identifier is operable to verify the digital identity for the vehicle.

2. The method of claim 1, wherein the step of creating the data pool is repeated so that the data pool includes one or more features unique to the vehicle.

3. The method of claim 1, wherein the first plurality of measurements are represented as a single array of data.

4. The method of claim 1, wherein a unique key is generated using a fuzzy extractor algorithm operable to process a level of noise within the first plurality of measurements, wherein the fuzzy extractor algorithm uses error-correcting data calculated from a predefined noise parameter and is used to adjust a measured fuzzy signal.

5. The method of claim 4, further comprising: calculating the error-correcting data from the data pool using a backend service.

6. The method of claim 4, further comprising: combining the unique key with a single authentication protocol.

7. The method of claim 4, further comprising: combining the unique key with a mutual authentication protocol.

8. The method of claim 4, wherein the unique key is stored on an external server.

9. The method of claim 4, further comprising: receiving a physical VIN associated with the vehicle, and wherein the physical VIN is used to generate the unique key.

10. The method of claim 4, further comprising:
sending an identity verification request to the vehicle;
receiving a second plurality of measurements acquired from the plurality of electronic control units located within the vehicle, wherein the second plurality of measurements are the physics-based metrics that are generated and unique to each of the plurality of electronic control units;
reconstructing the unique key associated with the second plurality of measurements, wherein the unique key is reconstructed by combining the second plurality of measurements with helper data generated from the first plurality of measurements; and
verifying whether the digital identity of the vehicle is valid using an authentication protocol to verify the unique key.

11. The method of claim 10, wherein the authentication protocol is a mutual authentication protocol.

12. The method of claim 10, wherein the authentication protocol is a single authentication protocol.

13. The method of claim 1, further comprising: generating helper data from the first plurality of measurements.

14. The method of claim 1, further comprising: generating a fuzzy fingerprint that includes an identity and a predetermined variance level for the first plurality of measurements.

15. The method of claim 1, wherein the physics-based metrics is an instantaneous energy value received from an energy source associated with the plurality of electronic control units.

16. The method of claim 1, wherein the first plurality of measurements are received from the vehicle to an external server using a secured transmission channel protocol.

17. A non-transitory computer-readable medium operable to generating a digital identity for a vehicle, the non-transitory computer-readable medium having computer-readable instructions stored thereon that are operable to be executed to perform the following functions:
receive a first plurality of measurements acquired from a plurality of electronic control units located within the vehicle, wherein the first plurality of measurements are physics-based metrics that are generated and unique to each of the plurality of electronic control units;
create a data pool from the first plurality of measurements; and
generate a unique identifier by combining at least two of the first plurality of measurements within the data pool, wherein the unique identifier is operable to verify the digital identity for the vehicle.

18. The non-transitory computer-readable medium of claim 17, wherein the first plurality of measurements are represented as a single array of data.

19. The non-transitory computer-readable medium of claim 17, wherein a unique key is generated using a fuzzy extractor algorithm operable to process a level of noise within the first plurality of measurements, wherein the fuzzy extractor algorithm uses error-correcting data to adjust a measured fuzzy signal.

20. A system of generating a digital identity for a vehicle comprising:
a backend service operating remote from the vehicle operable to:
receive a first plurality of measurements acquired from a plurality of electronic control units located within the vehicle, wherein the first plurality of measurements are physics-based metrics that are generated and unique to each of the plurality of electronic control units;
create a data pool from the first plurality of measurements; and
generate a unique identifier by combining at least two of the first plurality of measurements within the data pool, wherein the unique identifier is operable to verify the digital identity for the vehicle.
